(19) United States
(12) Patent Application Publication
(10) Pub. No.: US 2025/0214842 A1
(43) Pub. Date: Jul. 3, 2025

(54) Carbon Nanotube and Manufacturing Method Thereof

(71) Applicant: SK Innovation Co., Ltd., Seoul (KR)

(72) Inventors: Young Kwang Kim, Daejeon (KR); Soo Bean Kim, Daejeon (KR); Hyun Suk Chung, Daejeon (KR); Yong Bin Han, Daejeon (KR)

(21) Appl. No.: 19/003,060

(22) Filed: Dec. 27, 2024

(30) Foreign Application Priority Data
Jan. 3, 2024 (KR) 10-2024-0000758

(51) Int. Cl. C01B 32/16

(52) U.S. Cl. CPC C01B 32/16; C01B 2202/02; C01B 2202/06; C01P 2002/82

(57) ABSTRACT

A method for manufacturing carbon nanotubes according to embodiments of the present disclosure includes injecting a carbon source, a metal catalyst, a cocatalyst and a transport gas into a reactor, and heating the reactor to manufacture carbon nanotubes. A ratio of a molar flow rate of the carbon source to a molar flow rate of the metal catalyst is 350 to 1,300.

### CROSS-REFERENCE TO RELATED APPLICATION

This application claims priority to Korean Patent Application No. 10-2024-0000758 filed Jan. 3, 2024, the disclosure of which is hereby incorporated by reference in its entirety.

### BACKGROUND

### Technical Field

The present disclosure relates to a carbon nanotube and a method for manufacturing the carbon nanotube.

### Technical Considerations

Carbon nanotubes (CNTs) are materials used in many fields due to their excellent chemical stability and mechanical properties, as well as high thermal conductivity.

Depending on synthesis conditions, the carbon nanotubes are classified into: single-walled carbon nanotubes having a structure made by rolling up one layer of graphite and connecting ends thereof; double-walled carbon nanotubes having a shape in which two layers of the single-walled carbon nanotubes are arranged about a concentric axis; and multi-walled carbon nanotubes composed of a plurality of single-walled carbon nanotubes in a multi-layer.

As a method for synthesizing the carbon nanotubes, there are methods such as vapor deposition, electric discharge, laser ablation, high-pressure vapor deposition and the like. In order to manufacture carbon nanotubes with high efficiency, a method capable of synthesizing carbon nanotubes with high crystallinity while converting a carbon source at a high conversion ratio is required.

### SUMMARY

An object of the present disclosure is to provide a method for manufacturing carbon nanotubes capable of providing high-quality carbon nanotubes.

Another object of the present disclosure is to provide a carbon nanotube manufactured by the above method.

One or more of the above objects may be achieved by one or more of the embodiments disclosed herein.

In some non-limiting embodiments or aspects of the present disclosure, there is provided a method for manufacturing carbon nanotubes comprising: injecting a carbon source, a metal catalyst, a cocatalyst and a transport gas into a reactor; and heating the reactor to manufacture carbon nanotubes, wherein a ratio of a molar flow rate of the carbon source to a molar flow rate of the metal catalyst is 350 to 1,300.

In some embodiments, the ratio of the molar flow rate of the carbon source to the molar flow rate of the metal catalyst may be 400 to 700.

In some embodiments, a ratio of the molar flow rate of the carbon source to a molar flow rate of the cocatalyst may be 700 to 2,600.

In some embodiments, a ratio of the molar flow rate of the metal catalyst to a molar flow rate of the cocatalyst may be 1 to 3.

In some embodiments, a ratio of the molar flow rate of the carbon source to a molar flow rate of the transport gas may be 0.002 to 0.01.

In some embodiments, a ratio of the molar flow rate of the metal catalyst to a molar flow rate of the transport gas may be 0.7×10⁻⁵ to 2.7×10⁻⁵.

In some embodiments, the carbon source may comprise at least one selected from the group consisting of an alcohol having 1 to 10 carbon atoms, a carboxylic acid having 1 to 10 carbon atoms, a saturated aliphatic hydrocarbon having 1 to 10 carbon atoms, an unsaturated aliphatic hydrocarbon having 1 to 10 carbon atoms, and mixtures thereof.

In some embodiments, the metal catalyst may comprise an organometallic compound comprising at least one selected from the group consisting of iron, nickel, cobalt, and mixtures thereof.

In some embodiments, the cocatalyst may comprise at least one selected from the group consisting of thiophene, dimethyl disulfide, carbon disulfide, diphenyl sulfide, benzothiophene, and mixtures thereof.

In some embodiments, the transport gas may comprise an inert gas and hydrogen.

In some embodiments, a volumetric flow rate of hydrogen based on a total volumetric flow rate of the transport gas may be 10 to 30% by volume.

In some embodiments, a conversion ratio of the carbon source may be 2.1% to 10%, and the conversion ratio may be a percentage value of the number of carbons comprised in the carbon nanotube to the total number of carbons of the carbon source.

According to some non-limiting embodiments or aspects of the present disclosure, there is provided a carbon nanotube having a Raman R value of 40 to 50, which is defined by Equation 1:

$$Raman R = {I}_{G} / {I}_{D} . \qquad [ Equation 1 ]$$

In Equation 1, I_{G} is a peak intensity for an absorption region of 1,580 cm⁻¹ to 1,600 cm⁻¹ in a Raman spectrum obtained by Raman analysis for the carbon nanotube, and I_{D} is a peak intensity for an absorption region of 1,330 cm⁻¹ to 1,380 cm⁻¹ in the Raman spectrum.

In some embodiments, the carbon nanotube may comprise at least one selected from the group consisting of a single-walled carbon nanotube (SWCNT), a thin-walled carbon nanotube (TWCNT), a multi-walled carbon nanotube (MWCNT) and mixtures thereof.

In some embodiments, the carbon nanotube has an average aspect ratio of 10,000 to 20,000, and the average aspect ratio may be defined as an average value of a ratio of a length to a diameter of the carbon nanotube.

Through the methods for manufacturing carbon nanotubes according to some embodiments of the present disclosure, a ratio of converting (conversion ratio) a carbon source into carbon nanotubes may be high. Accordingly, the production efficiency of the carbon nanotubes may be increased.

The carbon nanotubes manufactured by the method for manufacturing carbon nanotubes according to some embodiments of the present disclosure may comprise an amorphous phase with a low content while having improved graphite crystallinity.

The carbon nanotubes manufactured by the method for manufacturing carbon nanotubes according to some embodiments of the present disclosure may have a high aspect ratio, thereby having a long chain shape, and a surface area of the carbon nanotubes is large, thereby it may be easy to cut them in a longitudinal direction. Accordingly, the carbon nanotubes may be used in various fields through a simple processing process.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view of an exemplary apparatus for manufacturing carbon nanotubes according to the principles of the present disclosure; and

FIG. 2 is a graph illustrating carbon source conversion ratios and I_{G}/I_{D} ratios of examples and comparative examples depending on a ratio of a molar flow rate of a carbon source to a molar flow rate of a metal catalyst according to the principles of the present disclosure.

### DETAILED DESCRIPTION

A method for manufacturing carbon nanotubes according to the present disclosure comprises the step of manufacturing carbon nanotubes by adjusting a ratio of a molar flow rate of a metal catalyst and a molar flow rate of a carbon source. In addition, the carbon nanotubes manufactured by the method according to the present disclosure may have improved graphite crystallinity.

Hereinafter, the present disclosure will be described in detail with reference to the accompanying drawings. However, the embodiments are merely illustrative and the present disclosure is not limited to the specific embodiments described by way of example.

Furthermore, throughout the disclosure, unless otherwise particularly stated, the word “comprise”, “include”, “contain”, or “have” does not mean the exclusion of any other constituent element, but means further inclusion of other constituent elements, and elements, materials, or processes which are not further listed are not excluded.

Unless the context clearly indicates otherwise, the singular forms of the terms used in the present specification may be interpreted as including the plural forms. As used herein, the singular form of “a”, “an”, and “the” include plural referents unless the context clearly states otherwise.

The numerical range used in the present disclosure comprises all values within the range comprising the lower limit and the upper limit, increments logically derived in a form and spanning in a defined range, all double limited values, and all possible combinations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present disclosure. Unless otherwise defined in the present disclosure, values which may be outside a numerical range due to experimental error or rounding off of a value are also comprised in the defined numerical range.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Hereinafter, unless otherwise particularly defined in the present disclosure, “about” may be considered as a value within 30%, 25%, 20%, 15%, 10%, 5%, 3%, 2%, 1%, 0.5%, 0.1%, 0.05% or 0.01% of a stated value. Unless indicated to the contrary, the numerical parameters set forth in this disclosure are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

According to some embodiments, carbon nanotubes may be manufactured by floating catalyst chemical vapor deposition (FC-CVD). The floating catalyst chemical vapor deposition method is a method capable of synthesizing carbon nanotubes by continuously supplying a catalyst and a carbon source as a raw material while spraying them. Accordingly, unlike batch-wise synthesis, it is possible to continuously produce the carbon nanotubes.

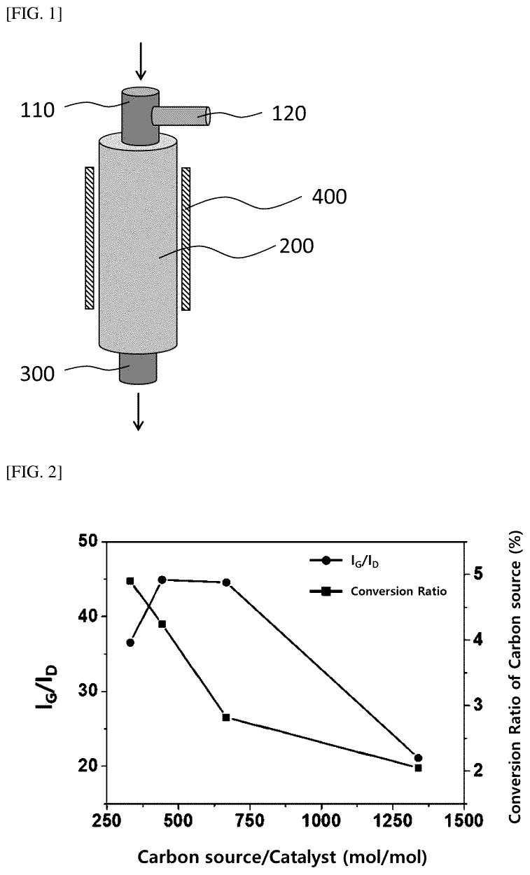

FIG. 1 is a schematic cross-sectional view of a non-limiting embodiment or aspect of an apparatus for manufacturing carbon nanotubes. Referring to FIG. 1, a carbon source, a metal catalyst, a cocatalyst and a transport gas are injected into a reactor 200, and then the reactor is heated to manufacture carbon nanotubes.

The carbon source is a raw material for carbon nanotubes, and may be an organic material for supplying carbon by being decomposed or performing a catalytic reaction at a high temperature. The phase of the carbon source may be a liquid or gaseous phase, and carbon atoms derived from the carbon source may diffuse into catalyst particles, thereby allowing carbon nanotubes to grow from the surface of the catalyst particles.

In some embodiments, the carbon source may comprise an alcohol having 1 to 10 carbon atoms, a carboxylic acid having 1 to 10 carbon atoms, a saturated aliphatic hydrocarbon having 1 to 10 carbon atoms, and/or an unsaturated aliphatic hydrocarbon having 1 to 10 carbon atoms. These may be used alone or in combination of two or more thereof.

In some embodiments, the alcohol having 1 to 10 carbon atoms may comprise methanol, ethanol, propanol, butanol, ethylene glycol, and/or polyethylene glycol, etc.

In some embodiments, the carboxylic acid having 1 to 10 carbon atoms may comprise acetic acid, and/or formic acid, etc.

In some embodiments, the saturated aliphatic hydrocarbon having 1 to 10 carbon atoms may comprise methane, ethane, propane, butane, pentane, and/or hexane, etc.

In some embodiments, the unsaturated aliphatic hydrocarbon having 1 to 10 carbon atoms may comprise ethylene, acetylene, methylacetylene, vinylacetylene, and/or mesitylene, etc.

The metal catalyst may function as a catalyst by itself, or may be decomposed or perform a reaction at a high temperature to be changed into an active catalyst or form active catalyst particles.

Accordingly, the active catalyst may promote the reaction of the carbon source to produce carbon nanotubes.

The metal catalyst may comprise a metal element such as iron, nickel, cobalt, platinum, ruthenium, molybdenum, and/or vanadium, etc., and may comprise, for example, an oxide of the metal element. These may be used alone or in combination of two or more thereof.

In some embodiments, the metal catalyst may comprise an organometallic compound comprising at least one selected from the group consisting of iron, nickel, cobalt, and mixtures thereof.

In some embodiments, the metal catalyst may comprise an organometallic compound comprising iron such as acetylferrocene, ferrocenemethanol, diacetylferrocene, iron(II) acetylacetonate, and/or ferrocene, etc., an organometallic compound comprising cobalt such as cobaltocene, and/or an organometallic compound comprising nickel such as nickellocene, etc. These may be used alone or in combination of two or more thereof.

The cocatalyst may inhibit the catalyst particles formed from the metal catalyst from excessively growing, thereby increasing a total surface area of the catalyst particles. Accordingly, manufacturing efficiency of the carbon nanotubes may be increased. In some embodiments, the cocatalyst may increase a speed at which carbon atoms diffuse to the surface of the catalyst particles, thereby increasing a production speed of the carbon nanotubes.

In some embodiments, the cocatalyst may comprise thiophene, dimethyl disulfide, carbon disulfide, diphenyl sulfide and/or benzothiophene, etc. These may be used alone or in combination of two or more thereof.

The transport gas (carrier gas) may be injected as a medium capable of floating the carbon source, the catalyst and the cocatalyst inside the reactor. The transport gas may comprise an inert gas and hydrogen. The inert gas is chemically stable and has little tendency to give, receive or share electrons, such that the reactant or product may be floated and moved without reacting with the carbon source or the manufactured carbon nanotubes.

The inert gas may comprise, for example, helium, nitrogen, neon, argon, krypton, and/or xenon, etc. These may be used alone or in combination of two or more thereof.

Referring to FIG. 1 again, the carbon source, the metal catalyst and the cocatalyst may be input into the reactor 200 through an inlet port 110 in the form of a mixture. In addition, the transport gas may be injected into the reactor 200 through a gas injection port 120.

Unlike as shown in FIG. 1, the carbon source, the metal catalyst and the cocatalyst may also be input through a separate inlet port, or a mixture of the carbon source, the metal catalyst, the cocatalyst and the transport gas may be introduced through the inlet port 110, and a separate transport gas may not be introduced through the gas injection port 120.

Flow rates of the carbon source, the metal catalyst, the cocatalyst and the transport gas may vary depending on the size of the reactor and each type thereof.

In some embodiments, the carbon source may be input at a flow rate of 1 to 40 ml/h. In some embodiments, the carbon source may be input at a flow rate of 0.0169 to 0.675 mol/h.

In some embodiments, the metal catalyst may be input at a flow rate of 9.44 to 378 mg/h. In some embodiments, the metal catalyst may be input at a flow rate of 5.07×10⁻⁵ to 2.03×10⁻³ mol/h.

In some embodiments, the cocatalyst may be input at a flow rate of 2.13 to 85.4 mg/h. In some embodiments, the cocatalyst may be input at a flow rate of 2.54×10⁻⁵ to 1.01×10⁻⁴ mol/h.

In some embodiments, the transport gas may be injected at a flow rate of 2 to 20 L/min. In some embodiments, the transport gas may be input at a flow rate of 4.99 to 49.9 mol/h.

According to some embodiments, a ratio of a molar flow rate of the carbon source to a molar flow rate of the metal catalyst is 350 to 1,300. According to some embodiments, the ratio of the molar flow rate of the carbon source to the molar flow rate of the metal catalyst may be 400 to 700 or 440 to 680.

When inputting the metal catalyst and the carbon source into the reactor at the molar flow rate ratio within the above range, an amount of the metal catalyst is appropriate, such that it may not act as an impurity while promoting the reaction of the carbon source.

When the ratio of the molar flow rate of the carbon source to the molar flow rate of the metal catalyst is greater than 1,300, the amount of the carbon source may be too much compared to the metal catalyst, thereby causing a reduction in the production speed of the carbon nanotubes.

When the ratio of the molar flow rate of the carbon source to the molar flow rate of the metal catalyst is less than 350, the metal catalyst may rather act as an impurity thereby inhibiting the production of carbon nanotubes, and the conversion ratio of the carbon source to the carbon nanotubes may be decreased.

In some embodiments, a ratio of the molar flow rate of the carbon source to a molar flow rate of the cocatalyst may be 700 to 2,600. According to some embodiments, the ratio of the molar flow rate of the carbon source to the molar flow rate of the cocatalyst may be 800 to 1,400. Within the above range, the amount of the cocatalyst is appropriate, such that it may not act as an impurity while increasing the activity of the catalyst.

In some embodiments, the ratio of the molar flow rate of the metal catalyst to the molar flow rate of the cocatalyst may be 1 to 3. In some embodiments, the ratio of the molar flow rate of the metal catalyst to the molar flow rate of the cocatalyst may be 1.5 to 2.5.

Within the above range, the cocatalyst may not act as an impurity or cause a side reaction in the reaction of the carbon source while increasing the effect of promoting the action of the metal catalyst by the cocatalyst.

In some embodiments, a ratio of the molar flow rate of the carbon source to a molar flow rate of the transport gas may be 0.002 to 0.01. In some embodiments, the ratio of the molar flow rate of the carbon source to the molar flow rate of the transport gas may be 0.009 to 0.01.

In some embodiments, a ratio of the molar flow rate of the metal catalyst to the molar flow rate of the transport gas may be 0.7×10⁻⁵ to 2.7×10⁻⁵. In some embodiments, the ratio of the molar flow rate of the metal catalyst to the molar flow rate of the transport gas may be 1.3×10⁻⁵ to 2.1×10⁻⁵. Within the above range, the carbon source and the metal catalyst may be more uniformly dispersed and flowed in a mixed state inside the reactor, and the efficiency of the carbon nanotube formation reaction may be improved. Accordingly, the productivity of the carbon nanotube may be improved.

In some embodiments, a volumetric flow rate of hydrogen based on a total volumetric flow rate of the transport gas may be 10% by volume to 30% by volume. Within the above range, hydrogen which can act as a reducing gas may promote the formation reaction of the carbon nanotubes.

The reactor may be heated in a state where the carbon source, the metal catalyst, the cocatalyst and the transport gas are injected into the reactor. Accordingly, the carbon source and the metal catalyst may be decomposed to form carbon atoms and catalyst particles, and carbon nanotubes may grow on the surface of the catalyst particles to produce carbon nanotubes.

In some embodiments, the reactor may be heated to a temperature of 1,000° C. to 2,000° C. In some embodiments, the reactor may be heated to a temperature of 1,000° C. to 1,700° C., 1,000° C. to 1500° C., or 1,000° C. to 1,300° C.

The produced carbon nanotubes may be discharged through an outlet port 300 to be obtained. For example, the carbon nanotubes may be wound at a lower end of the outlet port 300 to be obtained in the form of carbon nanotube fibers.

Accordingly, the decomposition of the carbon source and the catalyst and the growth of the carbon nanotubes may be smoothly performed.

In some embodiments, the conversion ratio of the carbon source may be 2.1% to 10%. In some embodiments, the conversion ratio of the carbon source may be 2.8% to 5% or 2.8% to 4.8%. Within the above range, the ratio at which the carbon source is converted into carbon nanotubes is high, thereby increasing the production efficiency of the carbon nanotubes.

The conversion ratio may be defined as a percentage value of the number of carbons comprised in the carbon nanotubes to the total number of carbons in the carbon source.

According to non-limiting embodiments or aspects of the present disclosure, provided is a carbon nanotube having a Raman R value of 40 to 50 which is defined by Equation 1 below.

$$Raman R = {I}_{G} / {I}_{D} . \qquad [ Equation 1 ]$$

In Equation 1, I_{G} is a peak intensity for an absorption region of 1,580 cm⁻¹ to 1,600 cm⁻¹ in a Raman spectrum obtained by Raman analysis for the carbon nanotube, and I_{D} is a peak intensity for an absorption region of 1,330 cm⁻¹ to 1,380 cm⁻¹ in the Raman spectrum.

In some non-limiting embodiments, the Raman R value of the carbon nanotube may be 43 to 47.

When satisfying the I_{G}/I_{D} value within the above range, graphite crystallinity of the carbon nanotube may be high, and a content of the amorphous phase acting as a defect may be low. Accordingly, a high-quality carbon nanotube may be implemented.

In some embodiments, the carbon nanotube may comprise at least one selected from the group consisting of a single-walled carbon nanotube (SWCNT), a thin-walled carbon nanotube (TWCNT), a multi-walled carbon nanotube (MWCNT), and mixtures thereof.

In some embodiments, the carbon nanotube may have an average aspect ratio of 10,000 to 20,000. The average aspect ratio may be defined as an average value of a ratio of a length to a diameter of the carbon nanotube.

Within the above range, the individual carbon nanotube may be suitable for use as a carbon nanofiber, and may be suitable for use as a conductive material for an electrode due to a large surface area thereof.

Hereinafter, experimental examples comprising specific examples and comparative examples are proposed to facilitate understanding of the present disclosure. However, the following examples are only given for illustrating the present disclosure and are not intended to limit the appended claims. It will be apparent those skilled in the art that various alterations and modifications are possible within the scope and spirit of the present disclosure, and such alterations and modifications are duly included in the present disclosure.

### Examples 1 and 2 and Comparative Examples 1 and 3

Carbon nanotubes of the examples and comparative examples were manufactured using the apparatus for manufacturing carbon nanotubes schematically shown in FIG. 1. Specifically, the metal catalyst, the cocatalyst, the carbon source and the transport gas were injected into the reactor 200 through the inlet port 110 as a mixture (feed) of the metal catalyst, the cocatalyst, the carbon source and the transport gas by using the molar flow rate ratios or the volumetric flow rates as described in Table 1 below. The temperature at the point where the raw material inlet port 110 of the reactor 200 was set to 100 to 400° C., and the temperature inside the reactor 200 was increased to 1000 to 1,500° C. using a heating furnace 400. The carbon nanotubes manufactured inside the reactor 200 were obtained from the outlet port 300. Ferrocene was used as the metal catalyst, thiophene was used as the cocatalyst, ethanol was used as the carbon source, and a mixed gas of argon and hydrogen was used as the transport gas. Table 2 illustrates the contents of the carbon source, the cocatalyst, and the metal catalyst based on a mass flow rate of the mixture (feed).

TABLE 1

| | | Carbon | Carbon | Metal | | | |
|---|---|---|---|---|---|---|---|
| | Feed | Source/ | source/ | catalyst/ | Carbon | | Metal |
| | volume | Transport | Metal | Transport | source/ | Hydrogen/ | catalyst/ |
| | Flow rate | Gas | catalyst | gas (×10⁻⁵ | Cocatalyst | Transport | cocatalyst |
| | (ml/hr) | (mol/mol) | (mol/mol) | mol/mol) | (mol/mol) | Gas (vol %) | (mol/mol) |
| Comparative | 10.00 | 0.00932 | 1341 | 0.695 | 2684 | 16.9 | 2 |
| Example 1 | | | | | | | |
| Example 1 | 10.00 | 0.00932 | 671 | 1.39 | 1338 | 16.9 | 2 |
| Example 2 | 10.00 | 0.00932 | 448 | 2.08 | 889 | 16.9 | 2 |
| Comparative | 10.00 | 0.00932 | 337 | 2.77 | 665 | 16.9 | 2 |
| Example 2 | | | | | | | |
| Comparative | 10.00 | 0.00626 | 337 | 1.86 | 665 | 16.9 | 2 |
| Example 3 | | | | | | | |

TABLE 2

| | Carbon source/feed | Metal catalyst/feed | Cocatalyst/feed |
|---|---|---|---|
| | (wt. %) | (wt. %) | (wt. %) |
| Comparative | 99.63 | 0.30 | 0.07 |
| Example 1 | | | |
| Example 1 | 99.26 | 0.60 | 0.14 |
| Example 2 | 98.90 | 0.90 | 0.20 |
| Comparative | 98.53 | 1.2 | 0.27 |
| Example 2 | | | |
| Comparative | 98.53 | 1.2 | 0.27 |
| Example 3 | | | |

### Experimental Example 1: Calculation of Conversion Ratio of the Carbon Source

The carbon source conversion ratios of each example and comparative example were calculated by calculating a percentage of the number of carbons included in the obtained carbon nanotubes to the total number of carbons of the input carbon source. The carbon source conversion ratios of each example and comparative example are shown in Table 3 below.

### Experimental Example 2: Raman Analysis of Carbon Nanotubes

Raman analysis was performed on the carbon nanotubes of the examples and comparative examples under the following conditions to obtain Raman spectra. From the Raman spectra, a peak intensity ratio (IG/ID) of the absorption region corresponding to a G band at about 1,580 cm⁻¹ to 1,600 cm⁻¹ and a peak intensity ratio of the absorption region corresponding to a D band at about 1,330 cm⁻¹ to 1,380 cm⁻¹ were calculated.
i) Raman spectrometer: in Via Raman Microscope, Renishaw (UK)
ii) Argon ion laser wavelength: 532 nm
iii) Exposure time: 10 seconds, the number of times of mapping: 10 times
iv) Detector: 1024 StreamLine CCD, Renishaw (UK)
v) Laser power: 1%
vi) Magnification: 20×

FIG. 2 illustrates the carbon source conversion ratios and I_{G}/I_{D} ratios of the examples and comparative examples calculated according to Experimental Examples 1 and 2 as a graph depending on the ratio of the molar flow rate of the carbon source to the molar flow rate of the metal catalyst. In addition, specific values are also shown in Table 3 below.

TABLE 3

| | Carbon source conversion | |
|---|---|---|
| | ratio (%) | IG/ID |
| Comparative Example 1 | 2.04 | 21.0 |
| Example 1 | 2.81 | 44.5 |
| Example 2 | 4.23 | 44.8 |
| Comparative Example 2 | 4.89 | 36.0 |
| Comparative Example 3 | 3.86 | 27.9 |

Referring to FIG. 2 and Table 3, the carbon source was converted into the carbon nanotubes at a high conversion ratio through the methods of the examples, and the manufactured carbon nanotubes had a high I_{G}/I_{D} ratio, which resulted in high graphite crystallinity of the carbon nanotubes.

However, the I_{G}/ID ratio of the carbon nanotubes manufactured in the comparative examples, in which the molar flow rate ratio of the carbon source to the molar flow rate of the metal catalyst was less than 350 or greater than 1,300, was lower than the I_{G}/I_{D} ratio of the carbon nanotubes of the examples. Accordingly, the carbon nanotubes of the comparative examples included more defects such as amorphous carbon than the examples.

The contents described above are merely an example of applying the principles of the present disclosure, and other configurations may be further included without departing from the scope of the present disclosure.

What is claimed is:

1. A method for manufacturing carbon nanotubes comprising:
injecting a carbon source, a metal catalyst, a cocatalyst and a transport gas into a reactor; and
heating the reactor to manufacture carbon nanotubes,
wherein a ratio of a molar flow rate of the carbon source to a molar flow rate of the metal catalyst is 350 to 1,300.

2. The method for manufacturing carbon nanotubes according to claim 1, wherein the ratio of the molar flow rate of the carbon source to the molar flow rate of the metal catalyst is 400 to 700.

3. The method for manufacturing carbon nanotubes according to claim 1, wherein a ratio of the molar flow rate of the carbon source to a molar flow rate of the cocatalyst is 700 to 2,600.

4. The method for manufacturing carbon nanotubes according to claim 1, wherein a ratio of the molar flow rate of the metal catalyst to a molar flow rate of the cocatalyst is 1 to 3.

5. The method for manufacturing carbon nanotubes according to claim 1, wherein a ratio of the molar flow rate of the carbon source to a molar flow rate of the transport gas is 0.002 to 0.01.

6. The method for manufacturing carbon nanotubes according to claim 1, wherein a ratio of the molar flow rate of the metal catalyst to a molar flow rate of the transport gas is 0.7×10⁻⁵ to 2.7×10⁻⁵.

7. The method for manufacturing carbon nanotubes according to claim 1, wherein the carbon source comprises at least one selected from the group consisting of an alcohol having 1 to 10 carbon atoms, a carboxylic acid having 1 to 10 carbon atoms, a saturated aliphatic hydrocarbon having 1 to 10 carbon atoms, an unsaturated aliphatic hydrocarbon having 1 to 10 carbon atoms, and mixtures thereof.

8. The method for manufacturing carbon nanotubes according to claim 1, wherein the metal catalyst comprises an organometallic compound comprising at least one selected from the group consisting of iron, nickel, cobalt, and mixtures thereof.

9. The method for manufacturing carbon nanotubes according to claim 1, wherein the cocatalyst comprises at least one selected from the group consisting of thiophene, dimethyl disulfide, carbon disulfide, diphenyl sulfide, benzothiophene, and mixtures thereof.

10. The method for manufacturing carbon nanotubes according to claim 1, wherein the transport gas comprises an inert gas and hydrogen.

11. The method for manufacturing carbon nanotubes according to claim 10, wherein a volumetric flow rate of hydrogen based on a total volumetric flow rate of the transport gas is 10 to 30% by volume.

12. The method for manufacturing carbon nanotubes according to claim 1, wherein a conversion ratio of the carbon source is 2.1 to 10%, and
the conversion ratio is a percentage value of the number of carbons comprised in the carbon nanotube to the total number of carbons of the carbon source.

13. A carbon nanotube having a Raman R value of 40 to 50, which is defined by Equation 1:
$$Raman R = {I}_{G} / {I}_{D} . \qquad [ Equation 1 ]$$
(in Equation 1, I_{G} is a peak intensity for an absorption region of 1,580 cm⁻¹ to 1,600 cm⁻¹ in a Raman spectrum obtained by Raman analysis for the carbon nanotube, and I_{D} is a peak intensity for an absorption region of 1,330 cm⁻¹ to 1,380 cm⁻¹ in the Raman spectrum).

14. The carbon nanotube according to claim 13, comprising at least one selected from the group consisting of a single-walled carbon nanotube (SWCNT), a thin-walled carbon nanotube (TWCNT), a multi-walled carbon nanotube (MWCNT), and mixtures thereof.

15. The carbon nanotube according to claim 13, wherein the carbon nanotube has an average aspect ratio of 10,000 to 20,000, and
the average aspect ratio is defined as an average value of a ratio of a length to a diameter of the carbon nanotube.
